(19) United States
(12) Patent Application Publication
(10) Pub. No.: US 2011/0183186 A1
(43) Pub. Date: Jul. 28, 2011

(54) SOLID STATE BATTERY

(75) Inventors: Johan Hendrik Klootwijk, Eindhoven (NL); Rogier Adrianus Henrica Niessen, Eindhoven (NL); Petrus Henricus Laurentius Notten, Waalre (NL); Nynke Verhaegh, Arnhem (NL); Willem Frederik Adrianus Besling, Eindhoven (NL)

(73) Assignees: NXP B.V., Eindhoven (NL); KONINKLIJKE PHILIPS ELECTRONICS N.V., EINDHOVEN (NL)

(21) Appl. No.: 13/121,247

(22) PCT Filed: Sep. 18, 2009
(86) PCT No.: PCT/IB2009/054095

§ 371 Date: Apr. 1, 2011

(30) Foreign Application Priority Data
Sep. 29, 2008 (EP) 08165425.3

(51) Int. Cl. H01M 10/02; H01M 10/04; H01M 4/04

(52) U.S. Cl. 429/160; 29/623.1; 29/623.5

(57) ABSTRACT

The present invention relates to a method of manufacturing a solid-state battery with a high flexibility. The method comprises the steps of: forming an arrangement of battery cells (2) on a first substrate layer and providing a barrier layer (5) between the battery cells and the first substrate layer, applying on the arrangement of battery cells on the side not covered by the first substrate layer a second substrate layer (13), and removing the first substrate layer completely from the barrier layer, applying on the barrier layer a third substrate layer (14). The present invention further refers to the solid-state battery manufactured according to the method, as well as to a device, including the solid-state battery.

### FIELD OF THE INVENTION

The present invention refers to a solid-state battery, and specifically to a flexible all-solid-state battery. The present invention further refers to a solid-state battery, as well as to a device, including a solid-state battery.

### BACKGROUND OF THE INVENTION

Currently, all-solid-state rechargeable batteries are thoroughly investigated as the future power source for small-scale electronic applications, like implantable devices. More and more applications arise where a fully flexible and small-sized power source is desired. This is especially necessary and advantageous in e.g. in-vivo applications like cochlear or retinal implants. This is because such batteries are having a greater safety without any potential discharge of liquid or gel electrolyte. Typically, currently available battery configurations involve a metal anode, a solvent-plasticized polyelectrolyte, and a composite cathode. Both electrodes and the electrolytes are solid. Such batteries are easy to miniaturize and tend to have a very long operation period, and specifically they do not have considerable changes in their performance with temperature.

Electrochemical energy sources based on solid-state electrolytes are known in the art, and basically such solid-state batteries can in general be processed on a silicon or an SOI wafer (SOI: silicon-on-insulator).

In this connection, reference WO 2005/027245 A2 discloses an electrochemical energy source, an electronic device and a method of manufacturing the energy source, wherein the energy source basically comprises a first and a second electrode, and an intermediate solid-state electrolyte separating the first electrode and the second electrode from each other. Specifically, the first electrode is formed at least partially by a conducting substrate on which the solid-state electrolyte and the second electrode are deposited. The solid-state electrolyte and the second electrode are formed as thin film layers on the substrate (first electrode). The arrangement on the substrate is provided in the form of a pattern, and particular cells of the energy source are arranged in respective hollow portions such as cavities, and the plural cells are linked to form the complete battery. In order to reduce the thickness of the arrangement of the layers of the solid-state battery, a part of the substrate which is supported by a support structure in order to consolidate the electrochemical energy source can be removed for improving the energy density of the energy source. For performing the adaptation of the substrate the “substrate transfer technology” STT may be applied.

Specifically, the battery arrangement obtained is transferred based on the substrate transfer technology to another carrier so that the part of the original silicon substrate (silicon carrier) can be removed, the remaining part of the substrate still forming the first electrode and stabilizing the complete arrangement.

The substrate transfer technology provides the advantage of fully processing the battery, including required high temperature annealing steps, before the battery is transferred to a flexible substrate. Moreover, by using the substrate transfer technology the generally followed deposition route or deposition order, dictated by the chemical compatibility of the individual layers (generally processing is performed from high to low temperature) can be altered, providing substantial deposition freedom.

The batteries as described above may accordingly form part of light weight portable power systems, and are also suitable due to their thin film structure for embedding energy storage into structural material or into or on particular components of a device to be supplied with power.

The solid-state batteries as described above in conjunction with the reference include the arrangement of battery cells which are provided on the substrate according to a predetermined pattern, and the nature, shape and dimensioning of the pattern are arbitrary. The battery composed of such cells can easily and rapidly be charged within a relatively short period of time depending upon the battery size and state of this charge, and can also be combined with energy-harvesting devices to provide miniature perpetual power systems. When the solid-state batteries are considered in view of charging and discharging, one of the major issues to be solved is the expansion/reduction of the plurality of layers during charging/discharging of the battery. In planar batteries this behavior is observed, but can be permitted. However, if three dimensional batteries (3D batteries) are considered, this will be one of the major mechanisms reducing the lifetime of such a battery. The substrate transfer technology (STT) is one aspect to support a solution of this problem.

Presently, planar thin film all-solid-state batteries are being developed by a number of companies and institutes. For producing such batteries, there are used in general rigid and thick substrates like silicon, glass, or mica (a group of silicate minerals). In order to enlarge the applicability of these planar systems, thin film solid-state batteries are now deposited on thick (somewhat) flexible substrates such as polyimide, Kapton, PEEK (polyketones, polyetheretherketone), and other polymers. In conjunction with this technology, thin film batteries with a certain degree of bendability can be produced.

Future small-scale electronic devices and applications will employ many types of (integrated) power sources. Currently, three dimensional (3D) integrated all-solid-state rechargeable batteries are being developed. Novel concepts (such as 3D integration) of all-solid-state rechargeable thin film Li-ion batteries are also described in reference WO 2005/027245 A2. Power sources based on such all-solid-state batteries can be advantageously used in many applications ranging from medical implantables (brain/nerve/muscle stimulation, implantable drug delivery), (bio) sensors and autonomous devices (SAND modules). However, reliability problems may still occur during the operation (charging and discharging) of a three dimensional battery (3D battery) as a result of layer stack expansion/shrinkage during battery operation.

### SUMMARY OF THE INVENTION

It is an object of the present invention, to provide an improved method of manufacturing a solid-state battery as well as the solid-state battery which can be constructed and manufactured in a relatively simple manner, while obtaining stress reduction during operation of the solid-state battery.

According to the present invention, this object is accomplished by a method of manufacturing a solid-state battery, a solid-state battery, as well as a device using the solid-state battery as set out in the appended claims.

The method of manufacturing a solid-state battery (electrochemical energy source) according to a first aspect of the present invention comprises the steps of: forming at least part of an arrangement of battery cells on a first substrate layer and providing a barrier layer between the battery cells and the first substrate layer, applying on the at least part of the arrangement of battery cells on the side not covered by the first substrate layer a second substrate layer, removing the first substrate layer completely from the barrier layer, and applying on the barrier layer a third substrate layer.

According to a second aspect, the present invention refers to a solid-state battery, comprising: an arrangement of battery cells, a lower substrate layer for embedding the arrangement of battery cells, a barrier layer arrangement between the lower substrate layer and the arrangement of the battery cells, an upper substrate layer covering the arrangement of battery cells, wherein the upper substrate layer and the lower substrate layer are elastic layers.

According to a third aspect the present invention further refers to device, including the above solid-state battery, or the solid-state battery manufactured according to the above-described method.

The solid-state battery manufactured according to the present invention and which basically includes a first and a second electrode as well as a solid-state electrolyte there-between, has at least one battery cell and preferably an arrangement (a plurality) of battery cells being formed on a silicon substrate (the first substrate layer) which constitutes the carrier of the solid-state battery during at least a part of the manufacturing process, that is, for several manufacturing steps. Specifically, the particular battery cells of the solid-state battery are provided on the first substrate layer, preferably according to a predetermined pattern, and a barrier layer is provided between the battery cells and the silicon substrate forming the carrier. Based on the substrate transfer technology (STT) transfer of the produced battery cells implemented on the one substrate to another substrate is made. In greater detail, on the other side of the battery cells opposite to the side of the silicon (first) substrate a further (different, upper) substrate is applied, and thereafter (that is, after transferring the battery cells to this different upper substrate) the silicon substrate is completely removed and the further (upper) substrate is involved in the function of a carrier.

The complete removal of the silicon (first) substrate is carried out until the barrier layer is reached, covering and thereby protecting the particular battery cells which have been embedded in the silicon (first) substrate before removal. The complete removal of the silicon substrate is supported by the barrier layer and this enables the possibility to add ductile-layers, i.e. to replace the silicon substrate by a further layer having the function of a stress relief layer to ensure a considerable reduction of stress during the operation of the solid-state battery.

As a result, a rechargeable all-solid-state battery can be obtained which is extremely high flexible since as the third layer replacing the silicon substrate a further flexible layer can be applied.

While in known manufacturing processes SOI wafers have to be used as a starting material for processing the solid-state battery and specifically the three dimensional battery (3D battery), which is very difficult, since 100 μm SOI is not a very commonly used material, the approach according to the present invention and as put forward in the appended claims allows the use of a standard silicon wafer as a starting material. The use of specific types of basic layers or substrates for starting material is not necessary, thereby reducing complexity and costs of the manufacturing process as standard products can be used without any loss of quality and reliability of the finally obtained product.

Moreover, after specific processing steps related to the substrate transfer technology have been applied, the silicon substrate can easily and completely be removed, the removal being supported by the barrier layer which is a stopping layer and which extends between the arrangement of the battery cells and the silicon substrate. That is, the barrier layer (stopping layer) benefits the complete removal of the silicon substrate. The complete removal makes way for the deposit of additional layers thereafter. This allows the application of flexible layers that can compensate/absorb the expansion or shrinkage of the layers of the solid-state battery during the operation of the battery including charging and discharging thereof. Moreover, the application of a further preferably flexible layer having a carrier function and a protection function for the battery cells, provides additional freedom in the manufacturing process and when choosing a three dimensional structure (3D structure).

Hence, the complete removal of the more rigid silicon layer and the application of a further flexible layer makes it possible to obtain an ultra flexible all-solid-state battery with a high durability and improved performance during extended lifetime so that a variety of further applications under very specific conditions is possible. The battery obtained by means of the manufacturing process according to the present invention is highly suitable for medical applications due to the durability and reliability in operation.

Preferred embodiments of the present invention are defined in the dependent claims.

In the method according to the first aspect of the present invention a further step is provided of completing the at least part of the arrangement of the battery cells when in previous steps the battery cells have not yet been completed. This allows a high degree of freedom when determining and performing the various steps according to the present invention for manufacturing the solid-state battery.

The second layer on the upper surface of the battery cells can be an elastic layer so that the flexibility of this film solid-state battery is enhanced. Furthermore, the battery cells may be arranged in cavities formed on the first substrate, and the barrier layer may cover the complete upper surface of the first substrate. This leads to a reduced height of the arrangement of plural layers of the battery cells, and the barrier layer protects the battery cells from any detriment due to subsequent manufacturing steps.

The second (upper substrate) layer may be a polyimide layer, ensuring the required flexibility of this layer. This layer functions as a new carrier.

In the method according to the present invention the third substrate layer may be an elastic layer for reducing stress on the arrangement of battery cells. A highly flexible structure of the solid-state battery can be obtained.

The barrier layer may be formed from at least one of SiO₂ and TiO₂ ensuring the desired resistivity and durability. The first substrate may be removed from the barrier layer by an etching process, this measure being supported by the barrier layer and leading to the removal of a rigid layer.

An interlevel dielectric layer may be deposited on at least part of the arrangement of the battery cells, and the second substrate layer may be provided on the interlevel dielectric layer. The interlevel dielectric layer protects the layer arrangement of the battery cells and is non-conductive.

In the solid-state battery according to the second aspect of the present invention the barrier layer may be formed from at least one of SiO₂ and TiO₂, and at least one of the upper and lower substrate layers may be a polyimide layer. Each battery cell of the arrangement of battery cells may be accommodated in a corresponding cavity provided in the lower substrate layer.

The device according to the third aspect of the present invention may include a solid-state battery as mentioned above. The device may also include a solid-state battery manufactured according to the method mentioned above.

The present invention is further elucidated by the following figures and examples which are not intended to limit the scope of the present invention. Specifically, the above-mentioned and other aspects of the invention will be apparent from and explained with reference to the embodiments described hereinafter.

### BRIEF DESCRIPTION OF THE DRAWINGS

In the following drawings

FIG. 1 shows the arrangement of the battery cells embedded in a first substrate,

FIG. 2 shows the battery cells of FIG. 1 additionally being covered by a second substrate layer,

FIG. 3 shows the battery cells being covered by the second substrate layer and having the first substrate removed,

FIG. 4 shows the battery cells being covered by the second substrate and now being embedded into a third layer, and

FIG. 5 shows a flowchart of the manufacturing process of the solid-state battery.

### DETAILED DESCRIPTION OF THE DRAWINGS

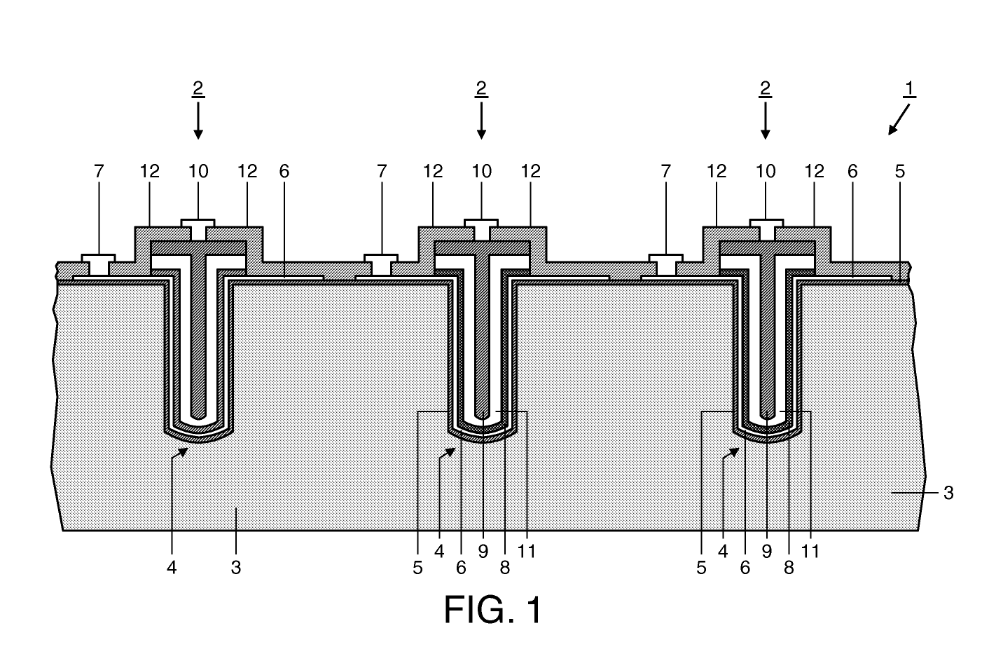

FIG. 1 of the drawings shows the arrangement of the solid-state battery 1 (electrochemical energy source) including a plurality of battery cells 2 formed on a first substrate layer 3. The first substrate layer 3 (in the following named first substrate 3) is formed by a silicon carrier wafer which can be a standard silicon wafer. This standard silicon wafer can be used as a starting material for the manufacturing process of solid-state battery 1. The first substrate constitutes a lower substrate (layer).

The particular battery cells 2 of which three cells are exemplified in FIGS. 1 to 4, are formed by stacking or depositing a plurality of different layers to obtain the desired structure and corresponding function.

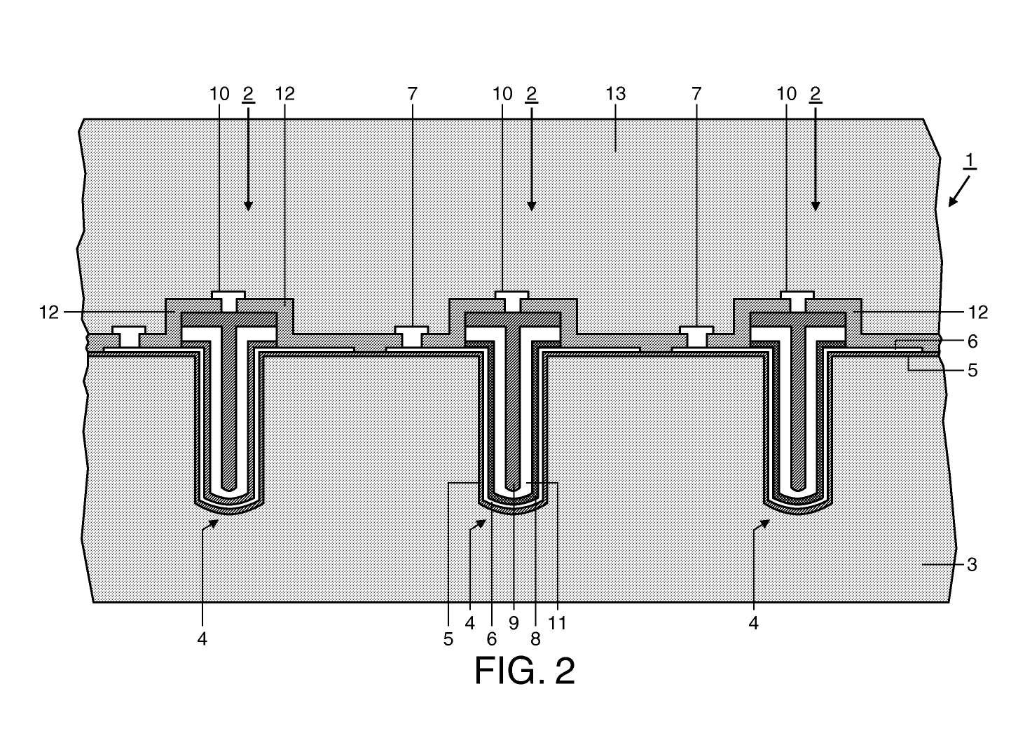

Specifically, on the silicon wafer forming the first (lower) substrate 3 recessed portions or cavities 4 are formed for accommodating at least part of the respective battery cells 2. On the thus structured surface of the first substrate 3 a barrier layer 5 is provided or deposited, as the first additional layer on the first substrate 3, completely mating with the structured surface of the first substrate 3, which is the upper surface in FIGS. 1 and 2.

The barrier layer may be formed on SiO₂ and TiO₂ and constitutes a persistent and stable layer between the battery cells 2 and the first substrate 3.

Thus, the first substrate 3 forms a crystalline silicon substrate which is open to the plural known processes for obtaining different structures in the first substrate 3 for obtaining predetermined electrical or mechanical properties and surface constitutions.

A further layer provided on the barrier layer 5 is formed as a current collector 6 which follows the shape of the recessed portions of the particular battery cells 2 and which may be interrupted between the particular battery cells 2. At least on one side of each battery cell 2 the current collector layer 6 is connected to a first contact portion 7 for providing connection of each battery cell to the outside.

The current collector layer 6 is at least in part on its run on the barrier 5 provided with a cathode layer 8 which forms the cathode of each of the battery cells 2. The cathode layer 8 of each battery cell 2 is connected via the current collector layer 6 and the first contact portion 7 to the outside.

In each recessed portion or cavity 4 provided respectively for each battery cell 2 an anode layer 9 is provided forming the anode of each battery cell 2. The anode layer is connected to a second contact portion 10 being provided for contacting the battery cell or the complete solid-state battery 1 to the outside.

That is, both contact portions 7 and 10 are provided for connecting the solid-state battery 1 to the outside. They may also be connected to each other in a certain manner to obtain a solid state battery 1 with different supply voltages, including a series connection of the particular battery cells 2, a parallel connection thereof, or a parallel and series connection of groups of battery cells 2 depending on the necessary supply voltage or current.

An electrolyte layer 11 is provided between the cathode layer 8 and the anode layer 9 which constitutes an intermediate layer forming a solid-state electrolyte between both electrodes of each battery cell 2 and mechanically and electrically separating the cathode layer and the anode layer 8 and 9 (electrodes).

As can be seen from the figures, part of the barrier layer 5, the current collector layer 6, the cathode layer 8, the anode layer 9 and the electrolyte layer 11 are accommodated in the recessed portions or cavities 4 of each battery cell 2, and specifically the current collector layer 6, the cathode layer 8, the anode layer 9 and the electrolyte layer 11 protrude to a certain extent from the upper surface of the first substrate 3, and specifically from the barrier layer 5 covering the upper surface of the first substrate 3. On the topmost point of the anode layer 9 the second contact portion 10 is arranged, and the further upper surface of the structure of the battery cells 2 obtained by depositing the above-described layers, except the areas where the first and second contact portions 7 and 10 are provided, are covered with an interlevel dielectric layer 12 for protecting and insulating the layer structure of each of the battery cells 2, basically the portion extending out of the cavities 4 in an upward direction in the figures.

The recessed portions or cavities 4 for accommodating the particular battery cells 2 may be provided in the first substrate 3 (silicon substrate), for example, by way of etching techniques. The dimensioning of the recessed portions or cavities 4 regarding width and depth may be arbitrary. The further layers are solid-state layers by means of deposition techniques. The first and second contact portions 7 and 10 may be provided on the basis of metal layers to form conducting portions.

The battery cells 2 of the solid-state battery 1 are according to the representation in FIG. 1 partly embedded in the first substrate 3 (silicon wafer) and a corresponding arrangement of the particular battery cells 2 is shown in FIG. 2. FIG. 2 further shows a second substrate layer 13 in the following named as second substrate 13. The second substrate 13 also constitutes an upper layer.

The second (upper) substrate 13 is formed on the upper surface of the layer structure of the battery cells 2, and specifically on at least a part of the upper surface of the interlevel dielectric layer 12.

The second substrate 13 is preferably provided on the basis of an elastic material, such as polyimide and is in view of strength and thickness suitable for forming a carrier of the particular battery cells 2 of the solid-state battery 1. Good chemical resistance and mechanical properties and flexural strength make a polyimide layer suitable for the purposes of a carrier. However, the present invention is not limited to this material, as any other material having same or corresponding properties can be used for providing the necessary carrier function. The second (upper) substrate 13 is therefore provided on the structure of the battery cells 2 opposite to the side where the first (lower) substrate 3 is arranged.

The application of the second substrate 13 provides the basis for the substrate transfer technology of the structure of the solid-state battery (3D battery) to base this structure on an alternative substrate.

The thickness and the material of the second (upper) substrate 13 to which the structure of solid-state battery 1 is being transferred can be chosen at will. Very thin foils of polymers (for example about 10 μm of polyimide) can result in fully flexible solid-state batteries 1.

The layer arrangement shown in FIG. 2 of the present invention depicts the structure of the solid-state battery 1 with two carrier layers in the form of the first and second substrates 3 and 13 (that is, including the lower and upper substrate).

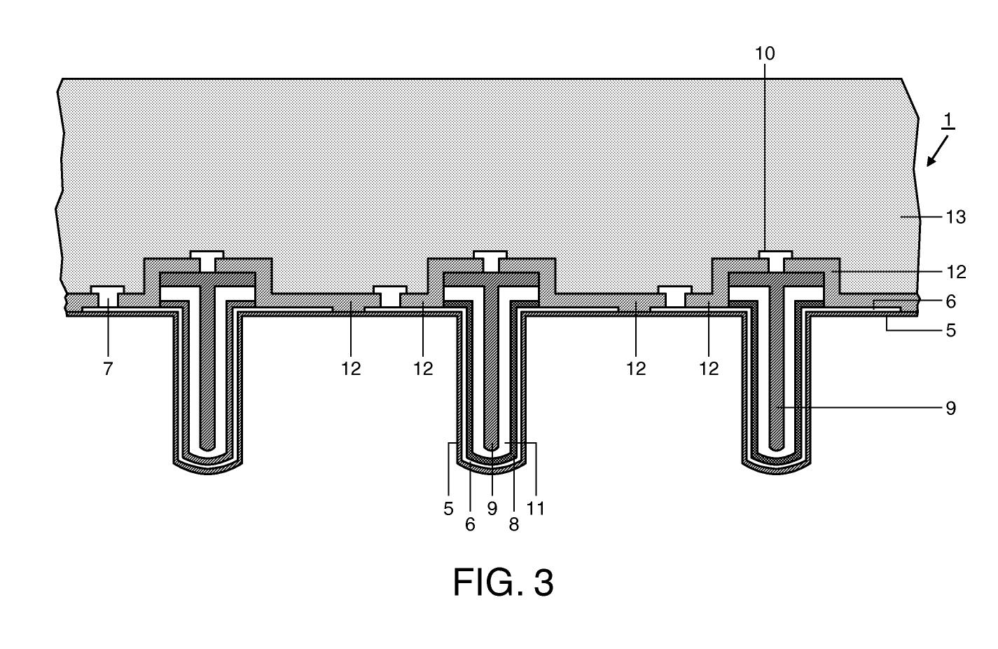

FIG. 3 shows a further arrangement of the same battery cells 2 of the solid-state battery 1, wherein the second substrate 13 is kept as it has been deposited on the structure of the solid-state battery 1, whereas the first substrate 3 (silicon substrate, silicon wafer) has been removed. Specifically, the first substrate (having the function of a carrier) is completely removed, for example, by an etching process. Easy and complete removal is possible since the barrier layer 5 is used as a Si-etching stopping layer, which protects the further layers of the particular battery cells 2 from being damaged. That is, the barrier layer 5 benefits the complete removal of the first substrate 3 (standard silicon substrate, lower substrate). The lowermost layer of the solid-state battery 1 after removing the first substrate 3 is formed by the barrier layer 5, and correspondingly the particular battery cells 2 of the solid-state battery 1 which have been accommodated in the recessed portions or cavities 4 provided in the first substrate 3 now form protruding portions extending downward in FIG. 3. The structure of a solid-state battery 1 is stabilized and supported by the second substrate 13 which functions as a carrier.

By means of the barrier layer 5 forming a stopping layer for the Si-etching process to remove the first substrate 3, it is possible to use a standard silicon wafer as the first substrate 3, and it is not necessary to make use of an expensive silicon-on-insulator wafer (SOI wafer). A regular etching process can be used to easily and completely remove the first (silicon, upper) substrate 13.

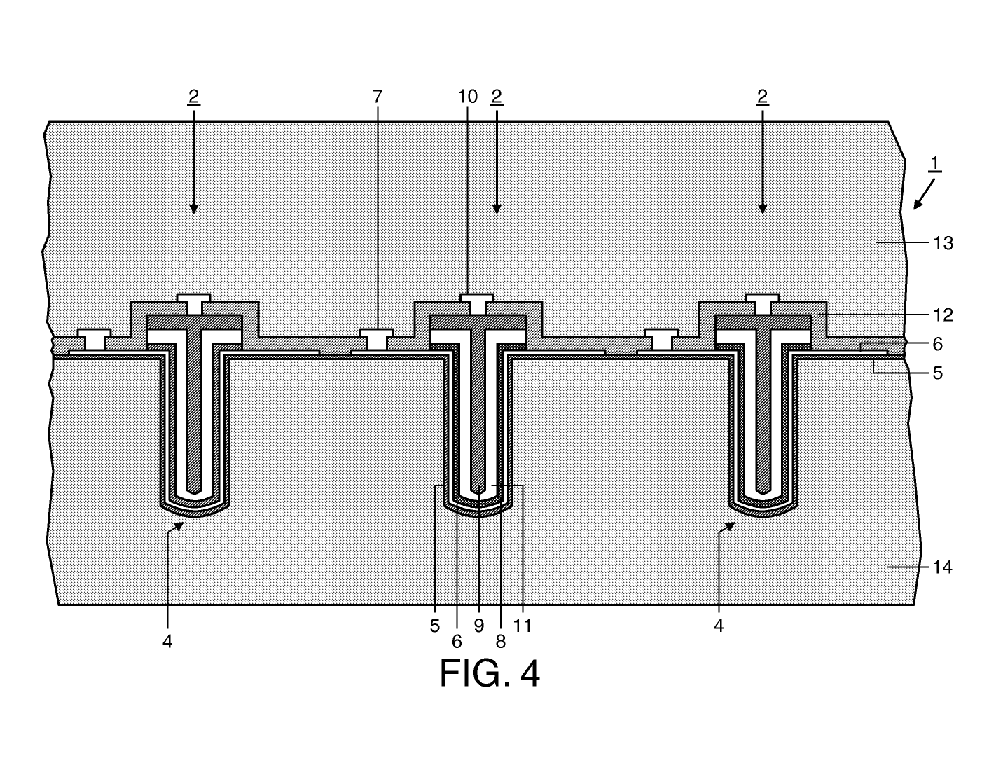

FIG. 4 shows a further production stage of producing or manufacturing the solid-state battery 1. In all figures the same reference numbers are used for respectively denoting the same items or components.

Specifically, the manufacturing stage shown in FIG. 3 is taken as a basic stage for providing on the side of the structure of the solid-state battery 1 where the first substrate 3 has been removed, a third substrate layer (third substrate) 14. That is, the third substrate 14 is applied to the lower surface of the manufacturing stage shown in FIG. 3, that is, on the lower surface of the barrier layer 5 and also constitutes a lower layer. The third substrate 14 may preferably be of an elastic material for forming a stress relief layer.

Specifically, after the alternative carrier in the form of the second substrate 13 (upper substrate layer) has been established as is shown in FIGS. 2 and 3 and the substrate transfer technology is completed, subsequent to the substrate transfer technology process the deposition of the third substrate 14 as an additional layer can be carried out. The third substrate 14 may provide the function of a stress relief layer which can absorb and/or mitigate expansion or shrinkage of the layers of the solid-state battery 1 during use of the solid-state battery 1 (charging and discharging of the battery), thereby considerably reducing the stress in the battery layer stack. That is, shrinking or expansion of the multi-layer structure of the solid-state battery 1 is absorbed or mitigated by the elasticity of the third substrate 14. This provides further freedom for choosing a 3D structure, such as a 3D structure of the solid-state battery 1 according to the present invention.

Accordingly, in conjunction with FIGS. 2 and 3 the basis structure shown in FIG. 1 has been subject to the substrate transfer technology, and it is described above the transfer of the 3D structure of the solid-state battery 1 to an alternative substrate, such as the second substrate 13, although completing the solid-state battery 1 before substrate transfer is preferred in general. Moreover, the structure of the solid-state battery 1 can be transferred to the second (upper) substrate 13 at any stage in the manufacturing process of the complete solid-state battery 1 (thin film battery). Specifically, transfer can be made of only the partially formed/deposited solid-state battery 1, consisting, for example, of only the combination of the cathode/electrolyte stack (cathode layer 8 and electrolyte layer 11), or the anode/electrolyte stack (anode layer 9 and electrolyte layer 11 as shown in the figures). As a result, the remaining part of the solid-state battery 1 which has up to now not been completed, can be deposited at a later stage, thereby breaking or altering the generally fixed deposition order in the manufacturing of the solid-state battery 1 according to the present invention. This option is possible since the remaining steps for completing (finalizing) the partially formed solid-state battery 1 are low temperature steps. The second substrate 13 (layer) can be removed before completing since the third substrate 14 is provided. This can be especially advantageous in the optimization of the individual battery layers.

The complete removal of the silicon substrate (silicon wafer) forming the first (lower) substrate 3 can be carried out due to the provision of the barrier layer 5 which can be used as a Si-etching stopping layer, and the use of expensive silicon-on-insulator wafers (SOI wafer) is no longer necessary. The complete removal of the first substrate 3 enables the deposition of layers that can absorb/mitigate expansion of the layers in the manufacturing process after carrying out the substrate transfer technology, so that with the deposition of such layers (for example the third substrate 14) the stress in the battery layer stack is reduced significantly. This aspect provides further freedom for choosing the above-described 3D structure of the solid-state battery 1. The stress reduction (stress relief) during the operation of the solid-state battery 1, such as charging and discharging, is possible due to the complete removal of the first substrate 3 (silicon carrier wafer) so that a rather rigid substrate (the silicon substrate) is replaced by a more flexible substrate (the third substrate 14) in conjunction with the flexible second substrate 13. Reduced stress during operation of the battery leads to a higher durability and extended product life with still reliable and excellent performance.

Specifically, the second and third substrates 13 and 14 are ductile layers and alone or in combination form stress absorbing layers, the optional deposition of such stress absorbing layers of different kind and strength being possible due to the complete removal of the first substrate 3 provided in the form of the silicon carrier wafer. The layer arrangement of the solid-state battery 1 according to the present invention is provided with two elastic layers (second and third substrates 13 and 14) without any layer having a greater rigidity and mechanical strength, the two ductile layers 13 and 14 sandwiching the arrangement of the (preferably plural) battery cells 2.

The solid-state battery 1 including a plurality of battery cells 2 according to the arrangement shown in FIG. 4 can be used for many applications due to the extreme high flexibility of the thin film solid-state battery 1. Such an improved power source which is integrated can advantageously be provided as a micro battery, be applied in small high-power electronic applications and can also be used in medical devices, such as implantable devices, hearing aids, autonomous network devices, nerve and muscle stimulation devices presence detection units and autonomous sensor systems for presence detection, operation detection and, for example, for tire pressure monitoring in a vehicle or commercial vehicles.

The flexible structure and reduced and adjustable size of the thin film solid-state battery 1 according to the present invention makes applications possible, wherein the battery with its shape and size has to be adapted to shape and size of any housing or device. Micro batteries can be manufactured based thereon. The strength of the second and third substrates 13 and 14 in conjunction with a high flexibility thereof further makes applications possible, wherein the thin film of the solid-state battery 1 must fit to any contour of a device or any component thereof or a housing of the device which is to be powered by the solid-state battery 1.

Hence, wide-spread applications are possible due to the fact that according to the above-described structure and process the solid-state battery 1 can be provided in the form of an ultra-flexible all-solid-state thin-film battery.

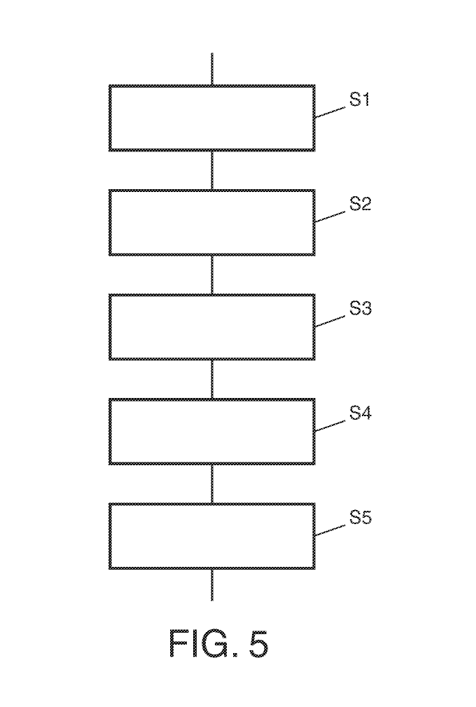

It is now referred to FIG. 5 representing the method as described above. FIG. 5 shows the arrangement of the sequence of the method steps in the form of a flowchart.

According to the foregoing description, the present method of manufacturing the solid-state battery 1 of the present invention may comprise a first step S1 of forming at least a part of an arrangement of the battery cells 2 on the first substrate (layer) 3 and further providing the barrier layer 5 between the battery cells 2 and the first substrate 3. That is, the battery cells 2 can be manufactured completely or can be manufactured to a certain extent, the further parts thereof being manufactured at a later stage of the process.

According to a second step S2, the process or method refers to applying on the arrangement of the battery cells 2 on the side not covered by the first substrate 3 (that is, the opposite side, the top side of the battery cells 2) the second substrate 13, the second substrate 13 having a predetermined flexibility. Thereafter, according to a third step of the method the first substrate 3 is completely removed from the layer arrangement obtained so far, specifically from the barrier layer 5, which is the intermediate layer between the first substrate 3 and the arrangement of the battery cells 2.

In a subsequent further step S4, on the barrier layer 5 the third layer 14 is provided. The third layer 14 may also be a flexible (ductile) layer.

Referring back to the first step S1, it is possible to provide on the first substrate (silicon substrate) 3 the plurality of battery cells 2 according to a predetermined arrangement or pattern (of array) which may be an arbitrary pattern depending upon the shape and the conditions of use of the solid-state battery. In case when only a part of the battery cells 2 has been formed or provided, in a further step S5 the battery cells for obtaining the solid-state battery can be completed. Specifically, the structural elements necessary for establishing the solid-state battery are provided.

However, in case in the first step S1 the battery cells 2 have already been implemented and formed completely, the additional step S5 is omissible.

This results in finally obtaining the solid-state battery 1 according to the present invention having the properties as described above in detail.

Thus, the manufacturing process (method) according to the present invention for producing the solid-state battery 1 allows a high degree of freedom of varying the sequence and nature of the manufacturing steps mentioned above. Basically, the sequence of providing at least part of the battery cells 2 on the first substrate 3, providing the second substrate 13, removing the first substrate 3 and replacing the first substrate 3 by the third substrate 14 is basically maintained. It is to be noted that the steps S1 to S3 correspond to the substrate transfer technology, and specifically according to the present invention complete removal of the first substrate is performed.

The metalized contact portions 7 and 10 may be respectively contacted to each other to obtain the desired solid-state battery 1 with different supply voltages and currents, including a series connection of the particular battery cells, a parallel connection thereof, or a group-related connection in parallel or in series, depending upon the supply voltage or current necessary for operating a particular device which has been equipped with and uses the solid-state battery according to the present invention as a power supply means or component.

While the invention has been illustrated and described in detail in the drawings and forgoing description, such illustration and description are to be considered illustrative or exemplary and the present invention is not limited to the disclosed embodiments.

Other variations to the disclosed embodiments can be understood and effected by those skilled in the art in practicing the claimed invention from study of the drawings, the disclosure, and the appended claims. In the claims, the word “comprising” does not exclude other elements or steps, and the indefinite article “a” or “an” does not exclude a plurality.

It is further to be noted that the drawings are of an exemplary nature and only show the structure and dimensions in a schematic manner, and the present invention is not limited to the exemplary dimensions, sizes and shapes of the components of the present invention. Any reference signs in the claims are not to be construed as limiting the scope of the present claims.

1. Method of manufacturing a solid-state battery, the method comprising the steps of:
forming at least part of an arrangement of battery cells on a first substrate layer and providing a barrier layer between said battery cells and said first substrate layer,
applying on said at least part of said arrangement of battery cells on the side not covered by the first substrate layer a second substrate layer,
removing said first substrate layer completely from said barrier layer, and
applying on said barrier layer a third substrate layer.

2. Method according to claim 1, further including the step of completing said at least part of said arrangement of the battery cells.

3. Method according to claim 1, wherein said second substrate layer on said upper surface of said battery cells is an elastic layer.

4. Method according to claim 1, wherein said battery cells are arranged in cavities formed on said first substrate layer, and said barrier layer covers the complete upper surface of said first substrate layer.

5. Method according to claim 1, wherein said second substrate layer is a polyimide layer.

6. Method according to claim 1, wherein said third substrate layer is an elastic layer for reducing stress on said arrangement of battery cells.

7. Method according to claim 1, wherein said barrier layer is formed from at least one of SiO₂ and TiO₂.

8. Method according to claim 1, wherein said first substrate layer is removed from said barrier layer by an etching process.

9. Method according to claim 1, wherein an interlevel dielectric layer is deposited on at least part of said arrangement of battery cells, and said second substrate layer being provided on said interlevel dielectric layer.

10. Solid-state battery, comprising:
an arrangement of battery cells,
a lower substrate layer for embedding said arrangement of battery cells,
a barrier layer arranged between said lower substrate layer and said arrangement of said battery cells,
an upper substrate layer covering said arrangement of battery cells, wherein said upper substrate layer and said lower substrate layer are elastic layers.

11. Solid-state battery according to claim 10, wherein said barrier layer is formed from at least one of SiO₂ and TiO₂.

12. Solid-state battery according to claim 10, wherein at least one of said upper and lower substrate layers is a polyimide layer.

13. Solid-state battery according to claim 10, wherein each battery cell of said arrangement of battery cells is accommodated in corresponding cavities provided in said lower substrate layer.

14. Device, including a solid-state battery as claimed in claim 10.

15. Device, including a solid-state battery manufactured according to the method of claim 1.
